(19) United States
(12) Patent Application Publication
(10) Pub. No.: US 2023/0296880 A1
(43) Pub. Date: Sep. 21, 2023

(54) RESIST MODELING METHOD FOR ANGLED GRATINGS

(71) Applicant: Applied Materials, Inc., Santa Clara, CA (US)

(72) Inventors: Yongan XU, Santa Clara, CA (US); Jin XU, Fremont, CA (US); William WILKINSON, Fremont, CA (US); Ludovic GODET, Sunnyvale, CA (US)

(21) Appl. No.: 18/123,085

(22) Filed: Mar. 17, 2023

Related U.S. Application Data
(60) Provisional application No. 63/269,524, filed on Mar. 17, 2022.

(51) Int. Cl. G02B 27/00

(52) U.S. Cl. CPC G02B 27/0012

(57) ABSTRACT

Methods of forming a resist model for angled gratings on optical devices. In one example, a method includes designing a model with a model area and a verification area with initial mask patterns having a first grating pattern with a first angle and a first critical dimension and fabricating test masks with the model area having a first model angle and a first model critical dimension and the verification area having a first verification angle and a first verification critical dimension. The method also includes patterning a substrate with the test masks, measuring the first model angle, the first model critical dimension, the first verification angle and the first verification critical dimension, and fabricating a new device mask if the first verification angle is within the threshold range of the first desired angle and the first verification critical dimension is within the threshold range of the first desired critical dimension.

### CROSS-REFERENCE TO RELATED APPLICATIONS

This application claims benefit to U.S. Provisional Patent Application 63/269,524, filed Mar. 17, 2022, which herein is incorporated by reference.

### BACKGROUND

### Field

Embodiments of the present disclosure generally relate to resist modeling used for Optical Proximity Correction. More specifically, embodiments described herein relate to a method of forming a model for angled gratings when processing optical devices.

### Description of the Related Art

Photolithography is widely used in the manufacturing of semiconductor devices and display devices, such as optical devices. These optical devices, for augmented, virtual, or mixed reality, may be fabricated from a substrate having a diameter of 200 mm or greater, such as a 200 mm or 300 mm substrate, i.e., a large-scale substrate. The large-scale substrate may then be processed to form multiple optical devices.

Conventionally, lithography techniques on a substrate to form an optical device pattern with straight lines on optical devices allows vertical or horizontal lines to be used to build a resist model. However, lines with different angles will have different resist metrology critical dimensions.

Accordingly, what is needed in the art is a system, a software application, and a method for resist models which can be used for optical device patterns with angled gratings.

### SUMMARY

In one embodiment, a method is provided. The method includes designing a model with a model area and a verification area of an optical device substrate with one or more initial mask patterns, the initial mask patterns having a first grating pattern with a first angle and a first critical dimension and fabricating one or more test masks, the one or more test masks having the first grating pattern with the model area having a first model angle and a first model critical dimension, with the verification area having a first verification angle and a first verification critical dimension, the first model angle is determined by comparing the first angle to a first desired angle and the first model critical dimension is determined by comparing the first critical dimension to a first desired critical dimension, the first model critical dimension and the first desired critical dimension are different. The method also includes patterning the model area and the verification area with the one or more test masks, measuring the model area for the first model angle and the first model critical dimension to complete the model and the verification area for the first verification angle and the first verification critical dimension of the first grating pattern at a first target point of the verification area, determining whether the first verification angle is within a threshold range of the first desired angle and the first verification critical dimension is within the threshold range of the first desired critical dimension, and fabricating a new device mask if the first verification angle is within the threshold range of the first desired angle and the first verification critical dimension is within the threshold range of the first desired critical dimension.

In another embodiment, a method is provided. The method includes designing a model with a model area and a verification area of an optical device substrate with one or more initial mask patterns, the initial mask patterns having a first grating pattern with a first angle, and fabricating one or more test masks, the one or more test masks having the first grating pattern with the model area having a first model angle and the verification area having a first verification angle, the first model angle is determined by comparing the first angle to a first desired angle. The method also includes patterning the model area and the verification area with the one or more test masks, measuring the model area for the first model angle to complete the model and the verification area for the first verification angle of the first grating pattern at a first target point of the verification area, and determining whether the first verification angle is within a threshold range of the first desired angle, and fabricating a new device mask if the first verification angle is within the threshold range of the first desired angle.

In another embodiment a non-transitory computer-readable medium storing instructions that, when executed by a processor, cause a computer system to perform steps is provided. The steps include designing a model with a model area and a verification area of an optical device substrate with one or more initial mask patterns, the initial mask patterns having a first grating pattern with a first angle and first critical dimension, and fabricating one or more test masks, the one or more test masks having the first grating pattern with the model area having a first model angle and a first model critical dimension, with the verification area having a first verification angle and a first verification critical dimension, the first model angle is determined by comparing the first angle to a first desired angle, and the first model critical dimension is determined by comparing the first critical dimension to a first desired critical dimension, the first model critical dimension and the first desired critical dimension are different. The steps also include patterning the model area and the verification area with the one or more test masks, measuring the model area for the first model angle and the first critical dimension to complete the model and the verification area for the first verification angle and the first verification critical dimension of the first grating pattern at a first target point of the verification area, determining whether the first verification angle is within a threshold range of the first desired angle and the first verification critical dimension is within the threshold range of the first desired critical dimension, and fabricating a new device mask if the first verification angle is within the threshold range of the first desired angle and the first verification critical dimension is within the threshold range of the first desired critical dimension.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic diagram of a lithography environment, according to embodiments.

FIG. 2 is a top view of an initial mask pattern, according to embodiments.

FIG. 3 is a flow diagram describing a method of creating a resist model for a metrology process, according to embodiments.

FIG. 4A is a schematic view of a model of a first mask, according to embodiments.

FIG. 4B is top down view of the optical device substrate patterned during the method of creating a resist model, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to resist modeling methods. More specifically, embodiments described herein relate to a method and non-transitory computer-readable medium of forming a model for arbitrary angled lines when processing optical devices.

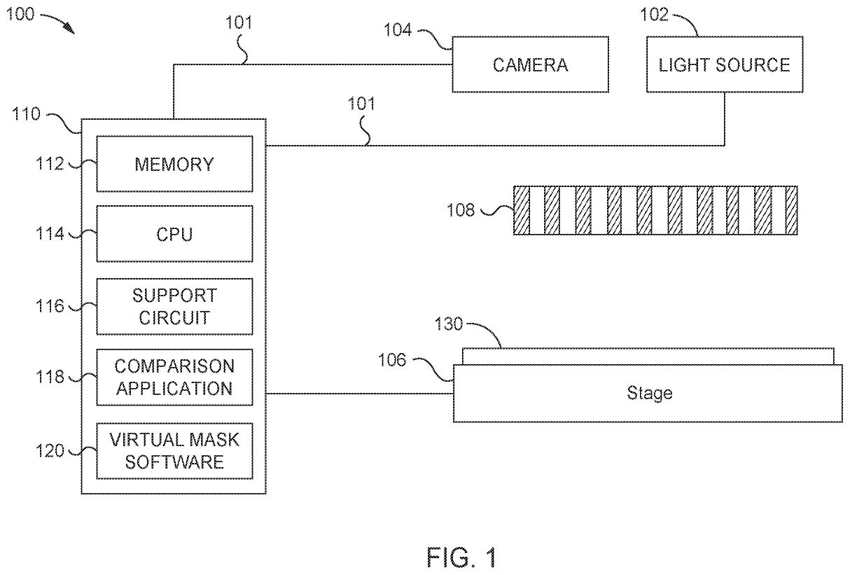

FIG. 1 is a schematic diagram of a lithography environment 100. The lithography environment includes, but is not limited to, a light source 102, a camera 104, a controller 110, a stage 106, and a mask 108. Communication links 101 connect the controller 110 to the camera 104, the light source 102, and the stage 106. The controller 110 includes a memory 112, a central processing unit (CPU) 114, a support circuit 116, a comparison application 118, and a virtual mask software application 120. The controller 110 is operable to facilitate the transfer of a digital pattern file (e.g., data) which is provided to the controller 110.

In some embodiments, the light source 102, the camera 104, and the stage 106 are each connected together via the communication links 101. The communication links 101 may include at least one of wired connections, wireless connections, satellite connections, and the like. The communication links 101 facilitate sending and receiving files to store data such as required for a method 300 further described herein. Transfer of data along communications links 101 can include temporarily or permanently storing files or data in the cloud, before transferring or copying the files or data. The communication links 101 allow for the controller 110, the light source 102, the camera 104, and the stage 106 to be in the same area or to be located in different areas.

The controller 110 is indexed to direct the method 300 operations described herein. The memory 112 is configured to store instructions corresponding to any portion of the method 300 described below. The CPU 114 can be one of any form of computer processor that can be used tin an industrial setting for controlling lithography environment devices. The memory 112 is coupled to the CPU 114. The memory can be one or more of readily available memory, such as random access memory (RAM), read only memory (ROM), floppy disk, hard disk, or any other form of digital storage, local or remote. The support circuits 116 are coupled to the CPU 114 to support the CPU 114. The support circuits 116 include cache, power supplies, clock circuits, input/output circuitry, subsystems, and the like.

In some embodiments, the controller includes one or more software applications, such as the comparison application 118 and the virtual mask software application 120. The controller can also include media data stored by the memory 112 that is used by the CPU 114 to perform the method 300 described herein. The CPU 114 can be a hardware unit or combination of hardware units capable of executing software applications and processing data. In some embodiments, the CPU 114 includes a digital signal processor (DSP), an application-specific integrated circuit (ASIC), and/or a combination of such units. The CPU 114 is configured to execute the one or more software applications, such as the comparison application 118 and the virtual mask software application 120, and process the stored media data, which can be included in the memory 112. The controller 110 controls data and file transfers to the light source 102, the camera 104, and the stage 106.

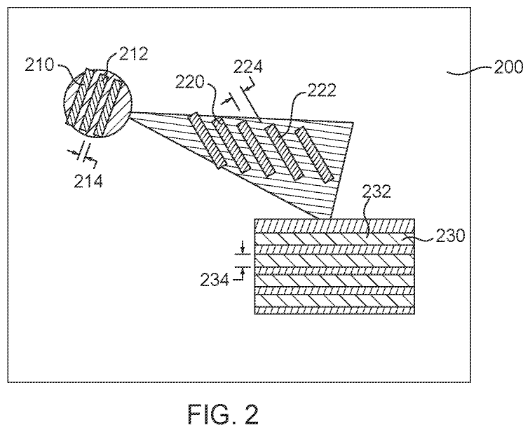

The controller 110 may facilitate the control and automation of a resist model metrology process based on the digital pattern file provided as shown in FIG. 2 below. The digital pattern file (or computer instructions), which may be referred to as an imaging design file, readable by the controller 110, determines which tasks are performable on a substrate. The digital pattern file corresponds to a pattern to be written into the photoresist using electromagnetic radiation output.

The digital pattern file may be provided in different formats. For example, the format of the digital pattern file may be one of a GDS format, and an OASIS format, among others. The digital pattern file includes information corresponding to features of exposure patterns to be generated on a substrate. The digital pattern file may include areas of interest which correspond to one or more structural elements. The structural elements may be constructed as geometric shapes (e.g. polygons).

The stage 106 is provided to support an optical device substrate 130. In some embodiments, the stage 106 is operable to move in the X and Y lateral position coordinates in real-time so that the location of the patterns can be accurately measured.

The light source 102 is configured to produce a light beam having a predetermined wavelength. The light source is any suitable light source, such as a light emitting diode (LED) or a laser, capable of producing light having a predetermined wavelength. In some embodiments, the light source 102 may include mircoLEDs, digital micromirror devices (DMDs), and liquid crystal displays (LCDs). In operation, the light source 102 is used to project the light through the mask 108 to the optical device substrate 130. The light source 102 is used to capture images with the camera 104. In some embodiments, the light source 102 is used to pattern the optical device substrate 130.

The camera 104 is configured to capture a plurality of images of the optical device substrate 130 when the light source 102 projects light through the mask 108 onto the optical device substrate 130. The images are stored in memory 112 for use by the comparison application 118. The comparison application 118 is executable to compare the images to the digital pattern file. The CPU 114 is configured to execute the comparison application 118 software program. In another embodiment, which can be combined with other embodiments described herein, the comparison application 118 may be a remote computer server which includes a controller and a memory (e.g., data store).

In some embodiments, the camera 104 is fixed over the stage 106 containing the optical device substrate 130. In some embodiments, the camera 104 may be movable over the surface of the optical device substrate 130. To allow for scanning of the surface. In other embodiments, more than one camera 104 may be used such that the entire field of view of all the cameras may view the entire optical device substrate 130.

The digital pattern file is provided to the controller 110. The digital pattern file contains a plurality of grating patterns. In some embodiments, the digital pattern file contains three grating patterns. The grating patterns of the digital pattern file have a plurality of desired angles and a plurality of desired critical dimensions. A first grating pattern 210 has a first desired angle and a first desired critical dimension. The controller 110 applies the virtual mask software application 120 to the digital pattern file. The virtual mask software application 120 can be a vMASC software. In one embodiment, which can be combined with other embodiments described herein, the virtual mask software application 120 is a software program stored in the memory 112. The CPU 114 is configured to execute the software program. In another embodiment, which can be combined with other embodiments described herein, the virtual mask software application 120 can be a remote computer server which includes a controller and memory (e.g., data store).

The digital pattern file is converted into a virtual mask file by the virtual mask software application 120. The virtual mask file is a digital representation of the design to be printed on the optical device substrate 130. The virtual mask file is used to develop the mask 108 for patterning the optical device substrate 130. In some embodiments, the mask 108 can be made from one or more initial mask patterns 200. The initial mask patterns 200 have a plurality of grating patterns including the first grating pattern 210. The first grating pattern 210 on the initial mask patterns 200 has a first angle 212 and a first critical dimension 214. The virtual mask file is provided to the camera 104, the light source 102, and the stage 106 via communication links 101.

The optical device substrate 130 comprises any suitable material, for example glass, which is used as part of an optical device. In other embodiments, which can be combined with other embodiments described herein, the optical device substrate 130 is made of other materials capable of being used as a part of an optical device. The optical device substrate 130 has a film layer to be patterned and formed thereon. A photoresist layer is formed on the film layer to be patterned. The photoresist layer is sensitive to electromagnetic radiation, for example ultraviolet (UV) or deep UV light.

The photoresist layer can be a positive or negative photoresist. After exposure, of the photoresist to the electromagnetic radiation, the photoresist is developed to become a patterned photoresist. Then using the patterned photoresist, the underlying film layer of the optical device substrate 130 is etched to have a pattern such as the first grating pattern 210.

While FIG. 1 depicts an exemplary embodiment of a photolithography system, other systems and configurations are contemplated herein to complete the method 300. For example, photolithography systems including any suitable number of stages are also contemplated.

FIG. 2 is a top view of the initial mask patterns 200. The first grating pattern 210, a second grating pattern 220, and a third grating pattern 230 are modeled on the initial mask patterns 200. In some embodiments, the first grating pattern 210 is an input coupler. In other embodiments the first grating pattern 210 is a pupil expander or an output coupler. In some embodiments, the second grating pattern 220 is the pupil expander. In some embodiments, the third grating pattern 230 is the output coupler. The first grating pattern 210 has the first angle 212 and the first critical dimension 214. The first angle 212 is an approximation to achieve the first desired angle. The first desired angle is an angle to be consistently patterned on the optical device substrate 130 according to a metrology process in the method 300. As stated above the first critical dimension 214 is located on the initial mask patterns 200. The first critical dimension 214 is an approximation to achieve the first desired critical dimension. The first desired critical dimension is a critical dimension to be consistently patterned on the optical device substrate 130 according to the metrology process in the method 300. The second grating pattern 220 has a second angle 222 and a second critical dimension 224. The second grating pattern 220 also has a second desired angle and a second desired critical dimension. The third grating pattern 230 has a third angle 232 and a third critical dimension 234. The third grating pattern 230 also has a third desired angle and a third desired critical dimension.

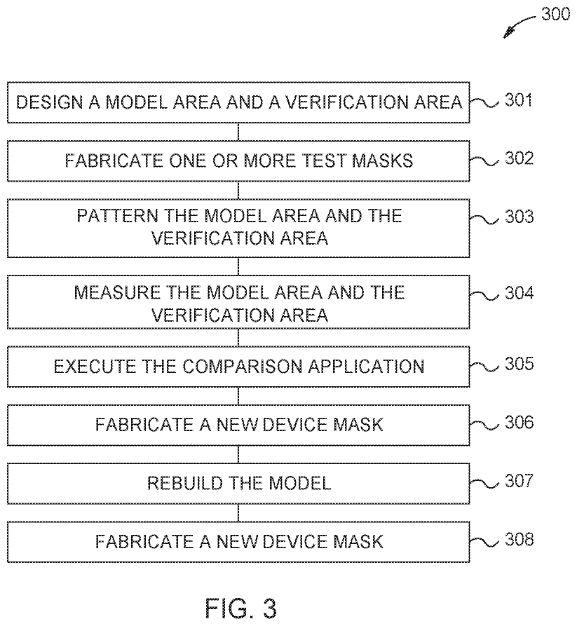

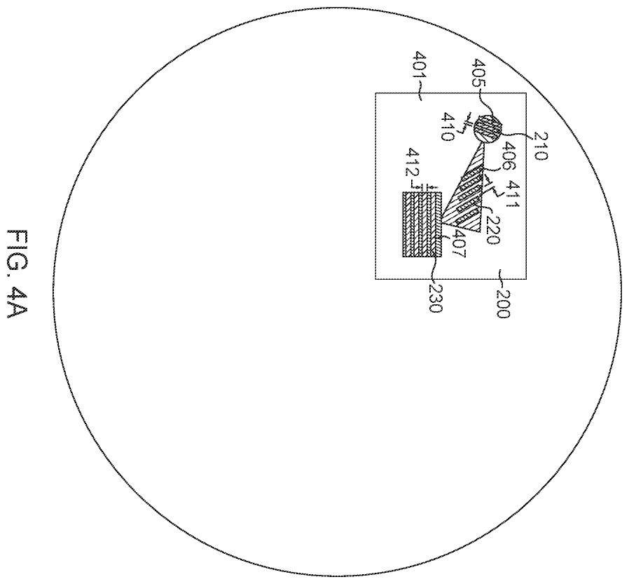

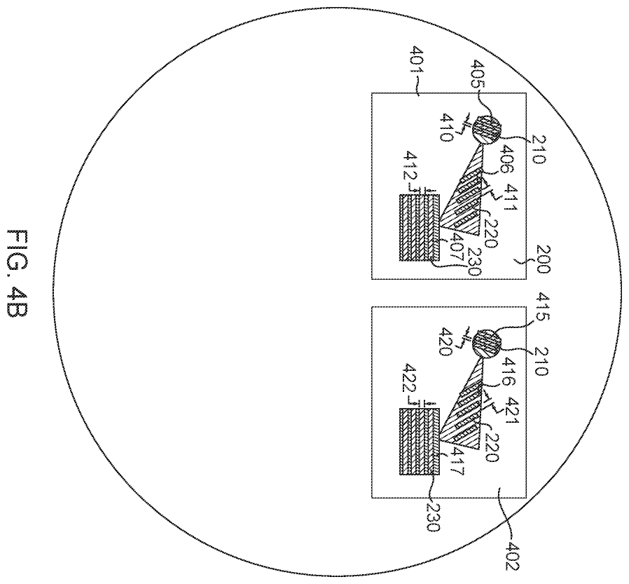

FIG. 3 is a flow diagram describing the method 300 of creating a resist model for a metrology process, according to embodiments described herein. FIG. 4A is a schematic view of a model of a first mask, according to embodiments. FIG. 4B is top down view of the optical device substrate 130 patterned during the method 300 of creating a resist model for a metrology process.

At operation 301, a model area 401 and a verification area 402 of the optical device substrate 130 is designed. The model area 401 and the verification area 402 are part of a model. The model is designed to correspond with the one or more initial mask patterns 200. The initial mask patterns 200 have the first grating pattern 210 with the first angle 212 and the first critical dimension 214 as described above. The digital pattern file contains the first desired angle and the first desired critical dimension. When the digital pattern file is converted to the virtual mask file the first desired angle is converted to the first angle 212 and the first desired critical dimension is converted to the first critical dimension 214. The initial mask patterns 200 with the model area 401 designed is shown in FIG. 4A.

The model includes the model area 401 and the verification area 402. The model is used to predict how the first desired angle and first desired critical dimension will be changed when printed on the optical device substrate 130. The model takes in to consideration the optical and chemical process parameters. In some embodiments, the first desired angle and first desired angle are the angle and critical dimension the model predicts will be produced using the first angle and the second critical dimension to pattern the optical device substrate 130.

In some embodiments, the one or more initial mask patterns 200 have the second grating pattern 220 with the second angle 222 and the second critical dimension 224. The digital pattern file contains the second desired angle and the second desired critical dimension. The second desired angle is converted into the second angle 222 and the second desired critical dimension is converted into the second critical dimension 224. The second grating pattern 220 is modeled concurrently with the first grating pattern 210.

In some embodiments, the one or more initial mask patterns 200 have the third grating pattern 230 with the third angle 232 and the third critical dimension 234. The digital pattern file contains the third desired angle and the third desired critical dimension. The third desired angle is converted into the third angle 232 and the third desired critical dimension is converted into the third critical dimension 234. The third grating pattern 230 is modeled concurrently with the second grating pattern 220.

At operation 302, one or more test masks are fabricated. The one or more test masks have the model area 401 with the first grating pattern 210 that includes a first model angle 405 and the first model critical dimension 410. The first model angle is determined by comparing the first angle 212 to the first desired angle. The test masks have the verification area 402 with the first grating pattern 210 that includes a first verification angle 415 and a first verification critical dimension 420. The first model angle 405 corresponds to the first angle 212. The first model critical dimension 410 corresponds to the first critical dimension 214. In some embodiments, the first model angle 405 is a set of first model angles such as ten first model angles. In some embodiments, the first model critical dimension 410 is a set of first model critical dimensions such as ten first model critical dimensions.

The first model critical dimension 410 is determined by comparing the first critical dimension 214 to the first desired critical dimension. The first model critical dimension 410 and the first desired critical dimension are different. The first model angle 405 and the first model critical dimension 410 are developed by the comparison application 118. The comparison application 118 compares the first angle 212 to the first desired angle to compute the first model angle 405 that will be used in the one or more test masks with the first verification angle 415 that matches the first desired angle. The comparison application 118 compares the first critical dimension 214 to the first desired critical dimension to compute the first model critical dimension 410 that will be used in the one or more test masks with a first verification critical dimension 420 that matches the first desired critical dimension. The comparison application 118 sends the first model angle 405, the first model critical dimension 410, the first verification angle 415, and the first verification critical dimension 420 to the virtual mask software application 120. The virtual mask software develops a new virtual mask file. The new virtual mask file is used to fabricate the one or more test masks.

In some embodiments, the one or more test masks have the second grating pattern 220 with a second model angle 406 and a second model critical dimension 411. Analogous to the first model angle 405, the second model angle 406 is calculated comparing the second angle 222 to the second desired angle. Analogous to the first model critical dimension 410, the second model critical dimension 411 is calculated comparing the second critical dimension 224 to the second desired critical dimension.

In some embodiments, the one or more test masks have the third grating pattern 230 with a third model angle 407 and a third model critical dimension 412. Analogous to the first model angle 405, the third model angle 407 is calculated comparing the third angle 232 to the third desired angle. Analogous to the first model critical dimension 410, the third model critical dimension 412 is calculated comparing the third critical dimension 234 to the third desired critical dimension.

At operation 303, the model area 401 and the verification area 402 are patterned. The model area 401 and the verification area 402 are patterned with the one or more test masks. The virtual mask file is used to direct the patterning of the optical device substrate 130. The optical device substrate 130 is patterned using a photolithography system. The optical device substrate 130 with the model area 401 and the verification area 402 patterned is shown in FIG. 4B. In some embodiments, the model area 401 and the verification area 402 are patterned with the first grating pattern 210, the second grating pattern 220, and the third grating pattern 230.

At operation 304, the model area 401 and the verification area 402 are measured. The model area 401 is measured for the first model angle 405 and the first model critical dimension 410 to complete the model. The changes in the first model angle and the first critical dimension from the test mask to the optical device substrate 130 are factored into the model. The verification area 402 is measured for the first verification angle 415 and the first verification critical dimension 420 to verify the model. The camera 104 captures an image of the model area 401 and the verification area 402 with the pattern. The image is analyzed by the controller 110. The controller 110 calculates the measurements. The measurements are sent to the comparison application 118. The first verification angle 415 corresponds to the first model angle 405. The first verification critical dimension 420 corresponds to the first model critical dimension 410. In some embodiments, the first verification angle 415 is a set of first verification angles such as ten first verification angles. In some embodiments, the first verification critical dimension 420 is a set of first verification critical dimensions such as ten first verification critical dimensions.

In some embodiments, the model area 401 and the verification area 402 are concurrently measured for the second model angle 406, the second model critical dimension 411, a second verification angle 416, and a second verification critical dimension 421 of the second grating pattern 220 at the second target point of the verification area 402. Those measurements are also sent to the comparison application 118. In some embodiments, the model area 401 and the verification area 402 are concurrently measured for the third model angle 407, the third model critical dimension 412, a third verification angle 417, and a third verification critical dimension 422 of the third grating pattern 230 at the third target point of the verification area 402. Those measurements are also sent to the comparison application 118.

At operation 305, the comparison application 118 is executed. The comparison application 118 uses the measurements of the first model angle 405 and the first model critical dimension 410 to complete the model. The comparison application 118 determines whether the first verification angle 415 is within a threshold range of the first desired angle and the first verification critical dimension 420 is within the threshold range of the first desired critical dimension. If the first verification angle 415 is within the threshold range of the first desired angle and the first verification critical dimension 420 is within the threshold range of the first desired critical dimension, the model is verified. Verification ensures that the model produces angles and the critical dimensions that are approximately the same as the first desired angle and the first desired critical dimension. Optional operation 306 is completed next. Patterning of the first grating pattern 210 can be performed with the desired angle and desired critical dimension being achieved. If the first verification angle 415 is outside the threshold from the first desired angle and the first verification critical dimension 420 is outside the threshold range from the first desired critical dimension, the model is not verified and optional operation 306 is skipped. The threshold range for line/space gratings is plus or minus 2 nm. The threshold range for two-dimensional gratings is plus or minus 6 nm.

In some embodiments, the comparison application 118 determines whether the second verification angle 416 is within the threshold range of the second desired angle and the second verification critical dimension 421 is within the threshold range of the second desired critical dimension. If the second verification angle 416 is within the threshold range of the second desired angle and the second verification critical dimension 421 is within the threshold range of the second desired critical dimension, the second model angle 406 and second model critical dimension 411 are verified.

In some embodiments, the comparison application 118 determines whether the third verification angle 417 is within the threshold range of the third desired angle and the third verification critical dimension 422 is within the threshold range of the third desired critical dimension. If the third verification angle 417 is within the threshold range of the third desired angle and the third verification critical dimension 422 is within the threshold range of the third desired critical dimension, the third model angle 407 and third model critical dimension 412 are verified.

At optional operation 306, a new device mask is fabricated. Optional operation 307 is performed if the first verification angle 415 is within the threshold range of the first desired angle and the first verification critical dimension 420 is within the threshold range of the first desired critical dimension. Since the first model angle 405 and first model critical dimension 410 have been verified the new device mask can be created for patterning optical device substrates 130 with the first grating pattern 210. The new device mask implements the optical proximity correction caused by the verification of the first model angle 405 and the first model critical dimension 410.

In some embodiments, the new device mask includes the second grating pattern 220 if the second model angle 406 and the second model critical dimension 411 are verified. In some embodiments, the new device mask includes the third grating pattern 230 if the third model angle 407 and the third model critical dimension 412 are verified.

At optional operation 307, the model is rebuilt. The model is rebuilt using the first model angle 405 and the first model critical dimension 410. The model is rebuilt if the first verification angle 415 is outside the threshold range of the first desired angle and the first verification critical dimension 420 is outside the threshold range of the first desired critical dimension. The comparison application 118 rebuilds the model using the first model angle 405, the first model critical dimension 410, and optical and chemical considerations.

In some embodiments, the second verification angle 416 is outside the threshold range of the second desired angle and the second verification critical dimension 421 is outside the threshold range of the second desired critical dimension. This causes the model to be rebuilt with respect to the second grating pattern 220.

In some embodiments, the third verification angle 417 is outside the threshold range of the third desired angle and the third verification critical dimension 422 is outside the threshold range of the third desired critical dimension. This causes the model to be rebuilt with respect to the third grating pattern 230.

Once the model is rebuilt, the comparison application 118 determines whether the first verification angle 415 is within the threshold range of the first desired angle and the first verification critical dimension 420 is within the threshold range of the first desired critical dimension. If the first verification angle 415 is within the threshold range of the first desired angle and the first verification critical dimension 420 is within the threshold range of the first desired critical dimension, optional operation 308 is performed. If the first verification angle 415 is outside the threshold range of the first desired angle and the first verification critical dimension 420 is outside the threshold range of the first desired critical dimension the model is rebuilt until the model can be verified.

In optional operation 308, like in optional operation 306, the new device mask is fabricated. If the first verification angle 415 is within the threshold range of the first desired angle and the first verification critical dimension 420 is within the threshold range of the first desired critical dimension, the first model angle 405 and the first model critical dimension 410 are verified. Since the first model angle 405 and first model critical dimension 410 have been verified, the new device mask can be created for patterning optical device substrates 130 with the first grating pattern 210.

In some embodiments, the new device mask includes the second grating pattern 220 if the second model angle 406 and the second model critical dimension 411 are verified. In some embodiments, the new device mask includes the third grating pattern 230 if the third model angle 407 and the third model critical dimension 412 are verified.

Aspects of the methods and apparatus provide significant advantages compared to conventional apparatus and methods. The methods provided allow for device metrology of optical device patterns with angled gratings. Conventional methods cannot be used for optical device patterns with angled gratings because gratings with different angles have different resist metrology critical dimensions even if the designed critical dimensions are the same. These methods provide a way to accurately perform device metrology for angled gratings of optical devices. These methods provide a way to implement optical proximity correction in the angled gratings of optical devices.

While the foregoing is directed to implementations of the present disclosure, other and further implementations of the disclosure may be devised without departing from the basic scope thereof, and the scope thereof is determined by the claims that follow.

What is claimed is:

1. A method, comprising:
designing a model with a model area and a verification area of an optical device substrate with one or more initial mask patterns, the initial mask patterns having a first grating pattern with a first angle and a first critical dimension;
fabricating one or more test masks, the one or more test masks having the first grating pattern with the model area having a first model angle and a first model critical dimension, with the verification area having a first verification angle and a first verification critical dimension, the first model angle is determined by comparing the first angle to a first desired angle and the first model critical dimension is determined by comparing the first critical dimension to a first desired critical dimension, the first model critical dimension and the first desired critical dimension are different;
patterning the model area and the verification area with the one or more test masks;
measuring the model area for the first model angle and the first model critical dimension to complete the model and the verification area for the first verification angle and the first verification critical dimension of the first grating pattern at a first target point of the verification area;
determining whether the first verification angle is within a threshold range of the first desired angle and the first verification critical dimension is within the threshold range of the first desired critical dimension; and
fabricating a new device mask if the first verification angle is within the threshold range of the first desired angle and the first verification critical dimension is within the threshold range of the first desired critical dimension.

2. The method of claim 1, further comprising:
rebuilding the model using the first model angle and the first model critical dimension if the first verification angle is outside the threshold range of the first desired angle and the first verification critical dimension is outside the threshold range of the first desired critical dimension;
determining whether the first verification angle is within the threshold range of the first desired angle and the first verification critical dimension is within the threshold range of the first desired critical dimension using the model; and
fabricating the new device mask if the first verification angle is within the threshold range of the first desired angle and the first verification critical dimension is within the threshold range of the first desired critical dimension.

3. The method of claim 1, further comprising:
designing the model to have a second grating pattern on the model area and the verification area of the optical device substrate with the one or more initial mask patterns, the initial mask patterns having the second grating pattern with a second angle and a second critical dimension;
fabricating the one or more test masks with the second grating pattern, the second grating pattern having a second model angle and a second model critical dimension on the model area and a second verification angle and a second verification critical dimension on the verification area, the second model angle is determined by comparing the second angle to a second desired angle and the second model critical dimension is determined by comparing the second critical dimension to a second desired critical dimension, the second model critical dimension and the second desired critical dimension are different;
patterning the second grating pattern on the model area and the verification area with the one or more test masks, wherein patterning the second grating pattern is performed concurrently with patterning the first grating pattern;
measuring the model area for the second model angle and the second model critical dimension to complete the model and the verification area for the second verification angle and the second verification critical dimension of the second grating pattern at a second target point of the verification area, wherein measuring the second grating pattern is performed concurrently with measuring the first grating pattern;
determining whether the second verification angle is within the threshold range of the second desired angle and the second verification critical dimension is within the threshold range of the second desired critical dimension; and
fabricating the new device mask with the second grating pattern if the second verification angle is within the threshold range of the second desired angle and the second verification critical dimension is within the threshold range of the second desired critical dimension.

4. The method of claim 3, further comprising:
designing the model to have a third grating pattern on the model area and the verification area of the optical device substrate with the one or more initial mask patterns, the initial mask patterns having the third grating pattern with a third angle and a third critical dimension;
fabricating the one or more test masks with the third grating pattern, the third grating pattern having a third model angle and a third model critical dimension on the model area and a third verification angle and a third verification critical dimension on the verification area, the third model angle is determined by comparing the third angle to a third desired angle and the third model critical dimension is determined by comparing the third critical dimension to a third desired critical dimension, the third model critical dimension and the third desired critical dimension are different;
patterning the third grating pattern on the model area and the verification area with the one or more test masks, wherein patterning the third grating pattern is performed concurrently with patterning the second grating pattern;
measuring the model area for the third model angle and the third model critical dimension to complete the model and the verification area for the third verification angle and the third verification critical dimension of the third grating pattern at a third target point of the verification area, wherein measuring the third grating pattern is performed concurrently with measuring the second grating pattern;
determining whether the third verification angle is within the threshold range of the third desired angle and the third verification critical dimension is within the threshold range of the third desired critical dimension; and
fabricating the new device mask with the third grating pattern if the third verification angle is within the threshold range of the third desired angle and the third verification critical dimension is within the threshold range of the third desired critical dimension.

5. The method of claim 1, wherein the first grating pattern is an input coupler, a pupil expander, or an output coupler.

6. The method of claim 4, wherein the second grating pattern is a pupil expander, and the third grating pattern is an output coupler.

7. The method of claim 1 wherein the first model critical dimension comprises a set of first model critical dimensions and the first verification critical dimension comprises a set of first verification critical dimensions.

8. The method of claim 7, wherein the set of first model critical dimensions comprises ten first model critical dimensions and the set of first verification critical dimensions comprises ten first verification critical dimensions.

9. A method, comprising:
designing a model with a model area and a verification area of an optical device substrate with one or more initial mask patterns, the initial mask patterns having a first grating pattern with a first angle;
fabricating one or more test masks, the one or more test masks having the first grating pattern with the model area having a first model angle and the verification area having a first verification angle, the first model angle is determined by comparing the first angle to a first desired angle;
patterning the model area and the verification area with the one or more test masks;
measuring the model area for the first model angle to complete the model and the verification area for the first verification angle of the first grating pattern at a first target point of the verification area;
determining whether the first verification angle is within a threshold range of the first desired angle; and
fabricating a new device mask if the first verification angle is within the threshold range of the first desired angle.

10. The method of claim 9, further comprising:
rebuilding the model using the first model angle if the first verification angle is outside the threshold range of the first desired angle;
determining whether the first verification angle is within the threshold range of the first desired angle using the model; and
fabricating the new device mask if the first verification angle is within the threshold range of the first desired angle.

11. The method of claim 9, further comprising:
designing the model to have a second grating pattern on the model area and the verification area of the optical device substrate with the one or more initial mask patterns, the initial mask patterns having the second grating pattern with a second angle;
fabricating the one or more test masks with the second grating pattern, the second grating pattern having a second model angle on the model area and a second verification angle on the verification area, the second model angle is determined by comparing the second angle to a second desired angle;
patterning the second grating pattern on the model area and the verification area with the one or more test masks, wherein patterning the second grating pattern is performed concurrently with patterning the first grating pattern;
measuring the model area for the second model angle to complete the model and the verification area for the second verification angle of the second grating pattern at a second target point of the verification area, wherein measuring the second grating pattern is performed concurrently with measuring the first grating pattern;
determining whether the second verification angle is within the threshold range of the second desired angle; and
fabricating the new device mask if the second verification angle is within the threshold range of the second desired angle.

12. The method of claim 11, further comprising:
designing the model to have a third grating pattern on the model area and the verification area of the optical device substrate with the one or more initial mask patterns, the initial mask patterns having the third grating pattern with a third angle;
fabricating the one or more test masks with the third grating pattern, the third grating pattern having a third model angle on the model area and a third verification angle on the verification area, the third model angle is determined by comparing the third angle to a third desired angle
patterning the third grating pattern on the model area and the verification area with the one or more test masks, wherein patterning the third grating pattern is performed concurrently with patterning the second grating pattern;
measuring the model area for the third model angle to complete the model and the verification area for a third verification angle of the third grating pattern at a third target point of the verification area, wherein measuring the third grating pattern is performed concurrently with measuring the second grating pattern;
determining whether the third verification angle is within the threshold range of the third desired angle; and
fabricating the new device mask if the third verification angle is within the threshold range of the third desired angle.

13. The method of claim 9, wherein the first grating pattern is an input coupler, a pupil expander, or an output coupler.

14. The method of claim 9, wherein the first model angle comprises a set of first model angles and the first verification angle comprises a set of first verification angles.

15. The method of claim 14, wherein the set of first model angles comprises ten first model angles and the set of first verification angles comprises ten first verification angles.

16. A non-transitory computer-readable medium storing instructions that, when executed by a processor, cause a computer system to perform the steps of:
designing a model with a model area and a verification area of an optical device substrate with one or more initial mask patterns, the initial mask patterns having a first grating pattern with a first angle and first critical dimension;
fabricating one or more test masks, the one or more test masks having the first grating pattern with the model area having a first model angle and a first model critical dimension, with the verification area having a first verification angle and a first verification critical dimension, the first model angle is determined by comparing the first angle to a first desired angle, and the first model critical dimension is determined by comparing the first critical dimension to a first desired critical dimension, the first model critical dimension and the first desired critical dimension are different;
patterning the model area and the verification area with the one or more test masks;
measuring the model area for the first model angle and the first critical dimension to complete the model and the verification area for the first verification angle and the first verification critical dimension of the first grating pattern at a first target point of the verification area;
determining whether the first verification angle is within a threshold range of the first desired angle and the first verification critical dimension is within the threshold range of the first desired critical dimension; and
fabricating a new device mask if the first verification angle is within the threshold range of the first desired angle and the first verification critical dimension is within the threshold range of the first desired critical dimension.

17. The non-transitory computer-readable medium of claim 16, wherein the computer system further performs the steps of:
rebuilding the model using the first model angle and the first model critical dimension if the first verification angle is outside the threshold range of the first desired angle and the first verification critical dimension is outside the threshold range of the first desired critical dimension;
determining whether the first verification angle is within the threshold range of the first desired angle and the first verification critical dimension is within the threshold range of the first desired critical dimension using the model; and
fabricating the new device mask if the first verification angle is within the threshold range of the first desired angle and the first verification critical dimension is within the threshold range of the first desired critical dimension.

18. The non-transitory computer-readable medium of claim 16, wherein the computer system further performs the steps of:
designing the model to have a second grating pattern on the model area and the verification area of the optical device substrate with the one or more initial mask patterns, the initial mask patterns having the second grating pattern with a second angle and a second critical dimension;
fabricating the one or more test masks with the second grating pattern, the second grating pattern having a second model angle and a second model critical dimension on the model area and a second verification angle and a second verification critical dimension on the verification area, the second model angle is determined by comparing the second angle to a second desired angle and the second model critical dimension is determined by comparing the second critical dimension to a second desired critical dimension, the second model critical dimension and the second desired critical dimension are different;
patterning the second grating pattern on the model area and the verification area with the one or more test masks, wherein patterning the second grating pattern is performed concurrently with patterning the first grating pattern;
measuring the model area for the second model angle and the second model critical dimension to complete the model and the verification area for the second verification angle and the second verification critical dimension of the second grating pattern at a second target point of the verification area, wherein measuring the second grating pattern is performed concurrently with measuring the first grating pattern;
determining whether the second verification angle is within the threshold range of the second desired angle and the second verification critical dimension is within the threshold range of the second desired critical dimension; and
fabricating the new device mask if the second verification angle is within the threshold range of the second desired angle and the second verification critical dimension is within the threshold range of the second desired critical dimension.

19. The non-transitory computer-readable medium of claim 18, wherein the computer system further performs the steps of:
designing the model to have a third grating pattern on the model area and the verification area of the optical device substrate with the one or more initial mask patterns, the initial mask patterns having the third grating pattern with a third angle and a third critical dimension;
fabricating the one or more test masks with the third grating pattern, the third grating pattern having a third model angle and a third model critical dimension on the model area and a third verification angle and a third verification critical dimension on the verification area, the third model angle is determined by comparing the third angle to a third desired angle, and the third model critical dimension is determined by comparing the third critical dimension to a third desired critical dimension, the third model critical dimension and the third desired critical dimension are different;
patterning the third grating pattern on the model area and the verification area with the one or more test masks, wherein patterning the third grating pattern is performed concurrently with patterning the second grating pattern;
measuring the model area for the third model angle and the third model critical dimension to complete the model and the verification area for the third verification angle and the third verification critical dimension of the third grating pattern at a third target point of the verification area, wherein measuring the third grating pattern is performed concurrently with measuring the second grating pattern;
determining whether the third verification angle is within the threshold range of the third desired angle and the third verification critical dimension is within the threshold range of the third desired critical dimension; and
fabricating the new device mask if the third verification angle is within the threshold range of the third desired angle and the third verification critical dimension is within the threshold range of the third desired critical dimension.

20. The non-transitory computer-readable medium of claim 16, wherein the first model critical dimension comprises a set of first model critical dimensions and the first verification critical dimension comprises a set of first verification critical dimensions.
